(19) United States
(12) Patent Application Publication
(10) Pub. No.: US 2005/0237476 A1
(43) Pub. Date: Oct. 27, 2005

(54) Liquid crystal display apparatus and method of scanning a color image

(76) Inventor: David A. Braun, Fort Collins, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/833,389

(22) Filed: Apr. 27, 2004

(51) Int. Cl. G02F 1/133

(52) U.S. Cl. 349/199

(57) ABSTRACT

There is disclosed a liquid crystal display device. The liquid crystal display device has a liquid crystal display and a backlight operable to illuminate an image located in register with the display separately in each color of a color separation. A plurality of sensors are incorporated within said liquid crystal display. Said sensors adapted to produce signals proportional to incident radiation. An image processor processes signals from the sensors corresponding to each of the colors to produce color image data. In one embodiment the color image data is subsequently displayed on the liquid crystal display.

### FIELD OF THE PRESENT INVENTION

The present invention relates generally to display systems and more particularly to a liquid crystal display apparatus and a method of scanning a color image.

### BACKGROUND TO THE INVENTION

Liquid crystal displays (LCD) are used in a variety of fields including miniature televisions, digital still and video cameras, computer monitors and personal digital assistants (PDAs). An LCD typically has two polarizing filters arranged at 90° to one another which would normally block all light trying to pass through the LCD from a backlight. However, between these polarizing filters are arranged twisted liquid crystals. The twisting of liquid crystals is achieved by sandwiching liquid crystals between finely grooved surfaces with the grooves on one surface perpendicular to the grooves on the other surface. When no voltage is applied, light supplied by the backlight passes through the first polarizing filter, is twisted through 90° by the liquid crystals before passing through the second polarizing filter.

However, when an electrical voltage is applied across the liquid crystal, the molecules realign vertically which allows the light to pass through the first polarizer and through the liquid crystals before being blocked by the second polarizer. Thus, in a typical LCD arrangement, no voltage equals lights passing through the LCD, while applied voltage equals no light emerging at the other end. LCD displays are typically divided into a number of cells or pixels which are individually addressable—i.e. a voltage can be specifically applied to the liquid crystal in that region. Color effects are achieved by overlaying additional red, green and blue colored filters over three separate LCD elements to create a single multi-colored pixel.

Thin film transistor (TFT) technology has been used to improve some LCD displays. Incorporating a thin film transistor layer provides an active matrix which improves response times and contrast ratios of LCD screens. TFT screens can also be made much thinner than conventional LCD devices. Typically, such TFT displays achieve a color effect by use of one transistor for each color. More recently there has been a move to introduce additional features to LCD displays, particularly where such displays are used for computer monitors or PDAs. Such features include touch screen technology and more recently the incorporation of a scanning capability into a liquid crystal display device.

With respect to thin film transistor displays, it is well known that as the number of transistors increases, the possibility of faulty transistors also increases. This is a known problem of miniaturization generally. Further, the more elements which are included in the transistor layer (transistors, sensors etc), the more opaque this layer becomes, thus requiring a brighter backlight and more power consumption. A still further known problem of LCD displays is that larger numbers of transistors and other circuit elements require more complicated driver technology.

Hence, there is need for a liquid crystal display device which overcomes one or more of the drawbacks identified above. Embodiments of the present invention satisfy one or more of these needs.

### SUMMARY

According to an embodiment of the invention, there is provided a liquid crystal display device. The liquid crystal display device has a liquid crystal display and a backlight operable to illuminate an image located in register with said display separately in each color of a color separation. A plurality of sensors are incorporated within said liquid crystal display wherein the sensors are adapted to produce signals proportional to radiation incident on the sensors. An image processor processes signals from said sensors corresponding to each of the colors in order to produce color image data.

In another embodiment of the invention there is provided a method of scanning a color image. The method involves scanning a color image locator relative to a display of a liquid crystal display device which has a plurality of light sensors and a multi-color backlight by controlling the backlight so that light from the backlight changes from each color in a color separation. Data is then captured from the light sensors for each color.

These and other objects, features and advantages of the preferred device and method will become apparent from the following detailed description, taken in conjunction with the accompanying drawings which illustrate exemplary embodiments of the invention.

### BRIEF DESCRIPTION OF THE DRAWINGS

FIG. 1 is a schematic diagram of a display device in accordance with an embodiment of the present invention;

FIG. 2 is a block diagram of a display device in accordance with an embodiment of the present invention; and

FIG. 3 is a flow chart showing a method of capturing a color image in accordance with an embodiment of the present invention.

FIG. 4 is a flow chart showing a method of another exemplary embodiment of the present invention.

### DETAILED DESCRIPTION OF THE DRAWINGS

Before proceeding with the detailed description, it is to be appreciated that the present invention is not limited to use or application within a specific type of display device. Thus, although the present invention is, for the convenience of explanation depicted and described with respect to typical exemplary embodiments, it will appreciated that this invention may be applied with other types of display device.

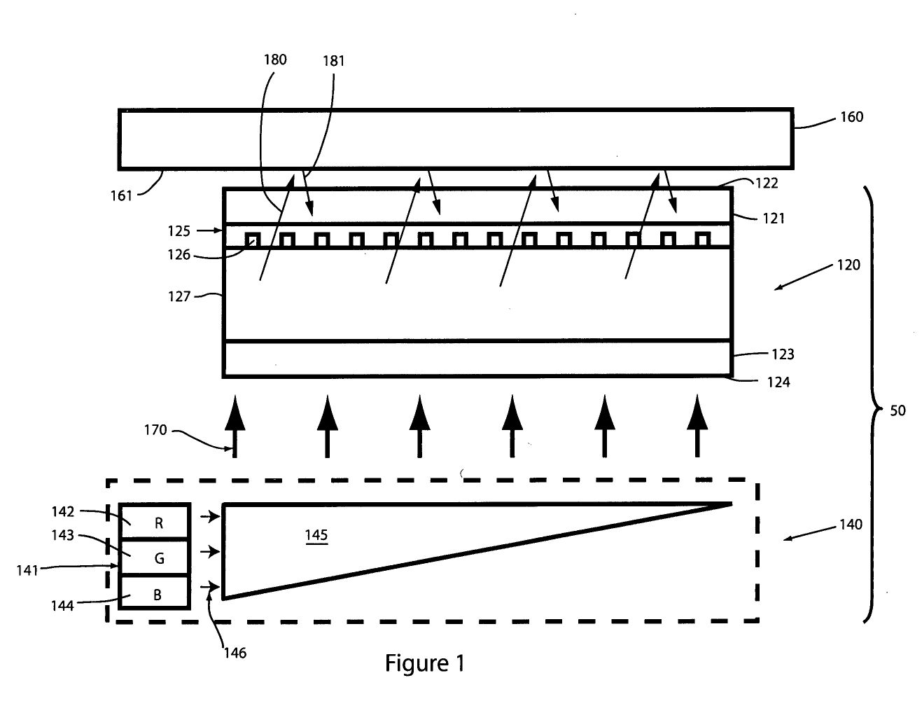

Referring now to the drawings, and in particular to FIG. 1, there is shown a liquid crystal display device 50 having a liquid crystal display 120 and a backlight 140.

In at least one embodiment, the liquid crystal display 120 includes a first polarizing layer 121 which defines a front viewable surface 122 of the liquid crystal display 120 and a second polarizing layer 123 which defines a rear surface 124 of the liquid crystal display 120.

The liquid crystal display 120 has a thin film transistor layer 125 which defines an array of individually addressable pixels and which are used to apply or not apply a voltage to the liquid crystal layer 127 to thereby control the alignment of the liquid crystal layer and hence whether light it is transmitted through the first polarizing layer 121. As illustrated schematically in FIG. 1, in at least one embodiment, the liquid crystal display 120 incorporates a plurality of light sensors 126. In at least one embodiment, there is a single light sensor for each pixel in the array of pixels defined by the thin film transistors. However, it will be appreciated by persons skilled in the art that the number of sensors may be varied.

In the exemplary embodiment, the backlight 140 has a multi-colored light source 141 which includes a plurality of red 142, green 143 and blue 144 light emitting diodes. Accordingly, it will be appreciated that the multi-colored backlight 141 provides the three colors of a color separation.

The multi-colored light source 141 is a side light and a light guide 145 is used to divert light from the multi-colored side light 141 which is incident on the light guide 145 as shown by arrows 146 to the incident of the rear surface 124 of the liquid crystal display 120 as indicated by arrows 170.

The light 170 is polarized by the second polarizing layer 123 and is either twisted through 90° by the liquid crystal layer 127 or allowed to pass through the liquid crystal layer without being twisted depending on the state of the individual transistors of the transistor layer 125. The light which is not twisted is blocked whereas the light which is twisted passes through the first polarizing layer 121.

In a display mode, each pixel of the transistor layer 125 is illuminated using the principle of field sequential lighting. In field sequential lighting, a color image is formed by presenting three monochromatic images corresponding to each color in the color separation, that is, red, green and blue, consecutively in a repetitive sequence and at a rate greater than the flicker fusion frequency for human vision.

Thus, each pixel of an image is processed and separated into individual red, green and blue image data. This data is used to control the individual pixels in a manner otherwise conventional for liquid crystal displays. A typical rate for sequential lighting is 180 hZ. Thus, in this embodiment, there only needs to be a single thin film transistor for all the colors which a pixel is required to display.

In a scanning mode of operation, multi-color backlight 140 is used advantageously in order to obtain color information from the object 160 to be scanned. The object to be scanned 160 will typically have a color image 161 on one face. Nevertheless, persons skilled in the art will appreciate that the display device 50 can also be used to capture black and white images.

During a scanning operation the image 161 to be captured is scanned by sequentially illuminating the image 161 with red, green and blue light by controlling the backlight 140. In one embodiment, the image is initially illuminated with red light as shown by arrows 180 and is reflected as shown by arrows 181 from the object 160.

Light sensors 126 receive the reflected red light 181 and output a signal proportional to the amount of radiation incident on the sensor. Thus, the signal is proportional to the amount of red light in the color image. The signals collectively provide red color data of the image. The process is then repeated with green and blue light to obtain green and blue data. This data collectively provides color image data of the image.

In one embodiment, separate red, green and blue data can be used directly to control the liquid crystal display device 50 to display the scanned color image on the viewable front surface 122. In another embodiment, the red, green and blue data is processed to form a color image data record. The color image data record can be used to control the display device 50 in a conventional manner or can be stored in a memory.

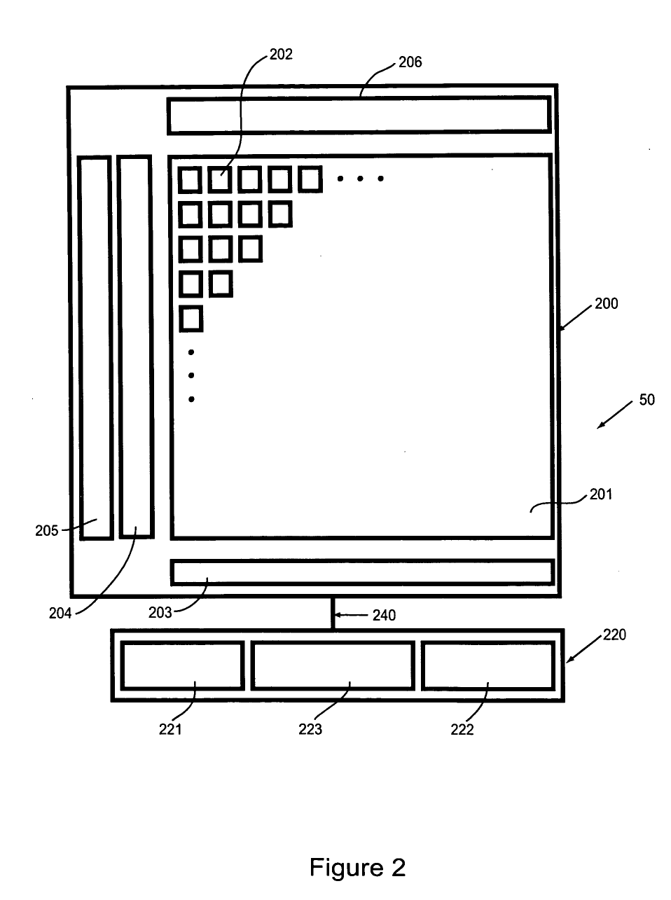

Referring to FIG. 2, there is a block diagram which shows how the display device 50 is controlled to address individual pixels in both display and scanning modes. As shown in FIG. 2, the display device 50 has an on-glass portion 200 and an off-glass portion 220 connected together by signal lines 240. The on-glass portion 200 includes a pixel array unit 201 having a plurality of pixels 202. Each pixel 202 has a thin film transistor (not shown) which controls whether the pixel is on or off and a sensor (not shown).

A signal line drive circuit 203 and a scan line drive circuit 204 are used to address individual thin film transistors using a suitable row and column technique as are known in the art. As the sensing of light is dependent on whether individual pixels are transmitting light, the signal line drive circuit 203 can also be used to control which sensors are being used to capture image data in conjunction with the sensor control circuit 205. In a typical embodiment, the sensors are controlled in order to obtain color data one row at a time. However, it will be appreciated that any number of scan patterns can be employed, for example, to reduce the effect of light reflected from neighboring parts of the image.

A sensor output circuit 206 receives and gathers signals from the sensors. Data from the sensor output circuit 206 is sent over signal lines 240 to the off-glass portion. Depending on the embodiment, this data is either stored in memory 221 or subjected to further processing by image processor 222 before being stored in memory 221. The memory 221 can be an EEPROM or any other suitable storage means, such as RAM, a hard drive, a removable media etc.

A control circuit 223 controls the signal line drive circuit 203, the scan line drive circuit 204, the sensor control circuit 205, and the sensor output circuit 206. The construction of appropriate circuits to perform these functions are well known in the art. Thus, the control circuit 223 acts as a display driver which can control the output of a color image on the display obtained from scanned color image data.

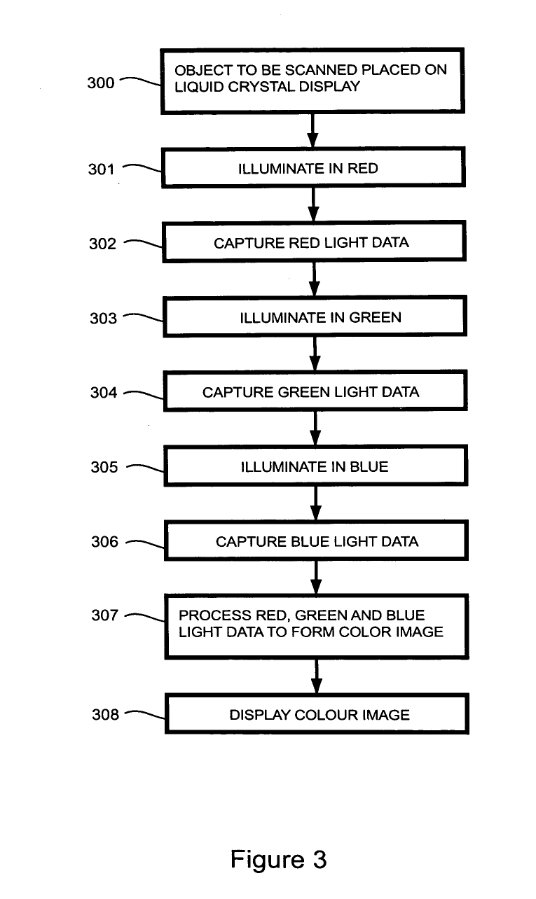

Accordingly, it will be appreciated that the apparatus can be used to carry out a method of scanning a color image as indicated in the flow chart of FIG. 3. In this method at step 300 an object to be scanned is placed on, or located in register with a liquid crystal display. The object is illuminated in red at step 301 and red light data is captured at step 302. The object is then illuminated in green light at step 303 and green light data is captured at step 304. At step 305, the object is illuminated in blue light and blue light data is captured at step 306. Thus, the image is scanned by controlling the light source which illuminates the object capturing red, green and blue light data.

At step 307 the method of an exemplary embodiment involves processing red, green and blue data to form colored data. The color image is then displayed on the display device at step 308 in order to allow the user to verify that the image has been correctly scanned.

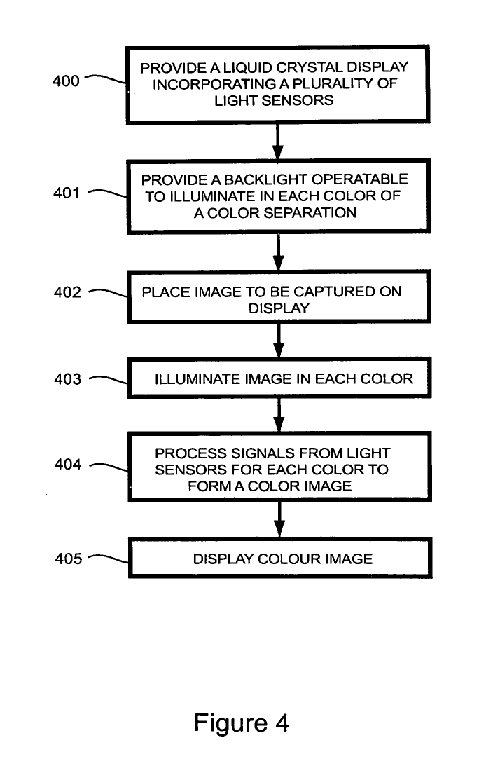

A method of another exemplary embodiment is illustrated in FIG. 4. At step 400 a liquid crystal display is provided which incorporates a plurality of light sensors. A backlight operable to provide illumination in each color of a color separation is provided at step 401. At step 402 an image is placed on the liquid crystal display provided at step 400.

In step 403 the image is illuminated in each color of the color separation. At step 404 the signals from the light sensors corresponding to separate illumination of the image by each of the colors are processed to form a color image. The color image is then displayed on the display at step 405.

It will be appreciated by persons skilled in the art that a number of alternative embodiments may be constructed. For example, any suitable lighting means may be used to illuminate the liquid crystal display. Such lighting means have the characteristic that they are capable of transmissively illuminating a liquid crystal display in plural colors sufficient to obtain color information from a color image to be scanned. These colors will typically be the three or more colors of a known color separation. However any number of color separations may be devised.

Further, while the use of light sensors and a sensor output circuit are used as image capture means for capturing image data of the object being scanned in each of the colors of the color separation, it will be appreciated that any number of image capture means may be used in alternative embodiments of the invention. For example, a pair of sensors may be used in the manner described in U.S. patent application publication no. US 2004/0008172 A1 in the name of Toshiba Matsushita Display Technology Co., Ltd. Or a plurality of scanning operations may be performed in order to obtain sufficient color data or the red, green and blue data may be subjected to additional processing to improve the quality of color data using suitable image processing techniques as are known to those in the art.

It will also be appreciated by persons skilled in the art that in other embodiments, a distributed liquid crystal display apparatus may be provided. For example, where the liquid crystal display apparatus and backlight are provided by a computer monitor the signals may be sent to a computer processor to carry out the processing.

Persons skilled in the art will also appreciate that the display device of the present invention is an active matrix color scanning display unit which has the advantage of both displaying images and capturing them.

It will be appreciated that at least one embodiment of the present invention has the advantage of only requiring one thin film transistor and one sensor for each pixel thus, reducing the complexity of each individual pixel. The less complex pixels can either be used to increase pixel density and hence the resolution of the liquid crystal display device or to improve the robustness of the device.

While the invention has been described with reference to the preferred embodiment, it will be understood by those skilled in the art that alterations, changes and improvements may be made and equivalents may be substituted for the elements thereof and steps thereof without departing from the scope of the present invention. In addition, many modifications may be made to adapt to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiments disclosed as the best mode contemplated for carrying out this invention, but that the invention will include all embodiments falling within the scope of the independent claims.

1. Liquid crystal display apparatus comprising:
a liquid crystal display;
a backlight operable to illuminate an image located in register with said display separately in each color of a color separation;
a plurality of sensors incorporated within said liquid crystal display, said sensors adapted to produce signals proportional to radiation incident on said sensors; and
an image processor for processing signals from said sensors corresponding to each of said colors to produce color image data.

2. Liquid crystal display apparatus as claimed in claim 1, wherein said backlight comprises light emitting diodes (LEDs) in each of said colors of said color separation.

3. Liquid crystal display apparatus as claimed in claim 2, wherein said backlight comprises a light guide and said LEDs are arranged as a side light for said light guide.

4. Liquid crystal display apparatus as claimed in claim 2, wherein said LEDs are red, green and blue LEDs.

5. Liquid crystal display apparatus as claimed in claim 1, further comprising a display driver for driving said liquid crystal display to display a color image corresponding to said color image data.

6. Liquid crystal display apparatus as claimed in claim 1, further comprising a memory for storing said color image data.

7. A liquid crystal display device comprising:
a liquid crystal display having a viewable front surface and a rear surface;
lighting means for illuminating said rear surface of said liquid crystal display to thereby illuminate an object placed on said viewable front surface, said lighting means for illuminating said object in each color of a color separation; and
image capture means for capturing image data of said object for each of said colors of said color separation.

8. A liquid crystal display device as claimed in claim 7, further comprising image processing means for processing said image data to form color image data.

9. A liquid crystal display device as claimed in claim 8, further comprising storage means for storing said color image data.

10. A liquid crystal display device as claimed in claim 8, further comprising data output means for controlling said liquid crystal display to display a color image corresponding to said color image data.

11. A liquid crystal display device as claimed in claim 7, wherein said lighting means comprises a field sequential lighting means comprising red, green and blue light emitting diodes (LEDs).

12. A liquid crystal display device as claimed in claim 11, wherein said LEDs form a side light and said lighting means comprises a light guide to direct light from said side light to illuminate said rear surface.

13. A liquid crystal display device as claimed in claim 7, wherein said image capture means comprises an array of light sensors.

14. An active matrix color scanning display unit, comprising:
a liquid crystal layer;
a transistor layer comprising a plurality of sensors, each sensor being for producing an electrical signal corresponding to radiation incident on the sensor;
a backlight for transmissively illuminating the liquid crystal and transistor layers, said backlight configured to output light during a scanning operation in plural colors sufficient to obtain color information from a color image to be scanned; and
an image processor for processing signals produced by said sensors during said scanning operation for each of said plural colors to produce data encoding said color image.

15. An active matrix color scanning display unit as claimed in claim 14, wherein said backlight comprises a light guide and red, green and blue LEDs.

16. An active matrix color scanning display unit as claimed in claim 14, further comprising a memory unit for storing data encoding said color image.

17. An active matrix color scanning display unit as claimed in claim 14, further comprising image output means for reading data encoding said color image from said memory and outputting an image corresponding to said liquid crystal display.

18. An active matrix color scanning display unit as claimed in claim 14, wherein said backlight is configured to output light sequentially in the colors red, green and blue.

19. A method of scanning a color image comprising:
scanning a color image located relative to a display of a liquid crystal display device having a plurality of light sensors and a multi-color backlight by controlling said backlight so that light from the backlight changes through each color in a color separation; and
capturing data from said light sensors for each color.

20. A method as claimed in claim 19, further comprising controlling said liquid crystal display device to display a color image corresponding to said captured data.

21. A method as claimed in claim 19, comprising controlling said backlight so that light from the backlight changes through the colors red, green and blue.

22. A method of capturing a color image comprising:
providing a liquid crystal display incorporating a plurality of light sensors;
providing a backlight operable to provide illumination in each color of a color separation;
placing an image to be captured on said display;
illuminating said image with each of said colors; and
processing signals from said light sensors corresponding to separate illumination of said image by each of said colors to form a color image.

23. A method as claimed in claim 22, wherein providing a backlight operable to provide illumination in each color of a color separation comprises providing a backlight comprising red, green and blue light emitting diodes.

24. A method as claimed in claim 22, further comprising displaying said color image on said liquid crystal display.
